(19) United States
(12) Patent Application Publication
(10) Pub. No.: US 2011/0109554 A1
(43) Pub. Date: May 12, 2011

(54) INTERACTIVE DISPLAY DEVICE AND METHOD, USING A DETECTION CAMERA AND OPTICAL POINTER

(75) Inventor: Alain Boissier, Villiers Saint Frederic (FR)

(73) Assignee: OPTINNOVA, Montigny-le-Bretonneux (FR)

(21) Appl. No.: 13/002,556

(22) PCT Filed: Jul. 3, 2009
(86) PCT No.: PCT/FR2009/051313

§ 371 Date: Jan. 4, 2011

(30) Foreign Application Priority Data
Jul. 4, 2008 (FR) 0854557

(51) Int. Cl. G06F 3/033

(52) U.S. Cl. 345/166

(57) ABSTRACT

In an interactive display device and method, a video projector projects an image on a screen. An optical pointer includes a mouse click signal input button and a light source emitting a light beam for pointing to the screen to form a light mark. A detection camera acquires an image from the screen and detects an image from the light mark. A processing system calculates the position of the light mark in the detected image. The optical pointer includes: a contact or proximity detector capable of detecting a contact between one end of the optical pointer and the screen and generating a light mark presence signal; and moreover a radio transmitter capable of transmitting a light mark presence signal to a processing system. The treatment system compared the respective signals for detecting a light mark and light mark presence to deduce therefrom a validation signal for the light mark.

The present invention relates to an interactive whiteboard.

More particularly, the invention relates to an interactive display system comprising an improved pointer. Such pointer provides a secured operation of the remote pointer function of the projection screen. According to an embodiment of the invention, the pointer further operates as an optical pen for performing direct entries in the projected digital images.

Many interactive display systems, commonly referred to as interactive whiteboards, are used today, in particular in schools or companies, to replace the blackboards or whiteboards written on with chalk sticks or marker pens.

Mainly two categories of interactive whiteboards exist: on the one hand, the systems that use a touch screen on which the user can interact by touching the touch screen, and on the other hand, the video projection and video-detection systems in which the user uses an optical pointer remote from the screen.

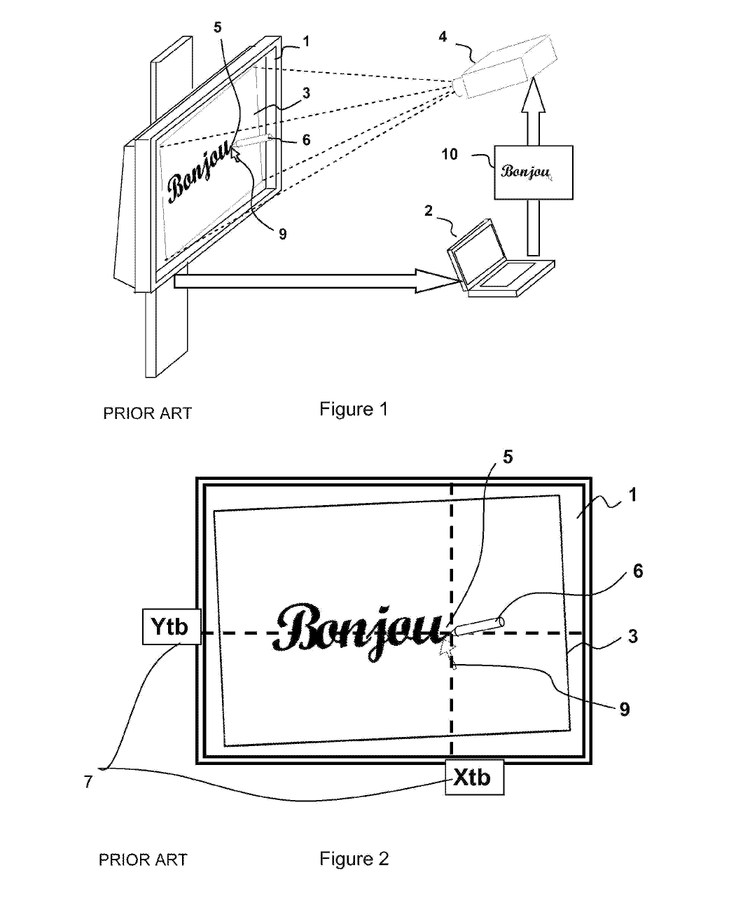

FIG. 1 shows a first conventional configuration of interactive whiteboard provided with a great-size touch screen (1), on which a video projector (4) connected to a computer (2) forms a projected image (3).

The general objective of this type of device is to permit the operator to control the operation of the computer (2) by directly acting on the touch screen (1). The latter functionally replaces the conventional computer mouse, permitting to control the computer cursor position and to remotely trigger the conventional right-click and left-click usually present on such mice.

In this type of apparatus, the touch screen (1) also serves as a projection and display screen. The touch function can be performed through resistive, capacitive, electromagnetic, optical or ultrasonic technologies. In all the cases, the touch detection system is integral with the screen.

An operator that uses such interactive whiteboard can point to any point (5) of the touch screen (1) with his/her finger or a pen (6) adapted to the touch detection system.

FIG. 2 shows the coordinates (Xtb, Ytb) (7) of the point (5) pointed by the operator in a coordinate system attached to the touch screen (1).

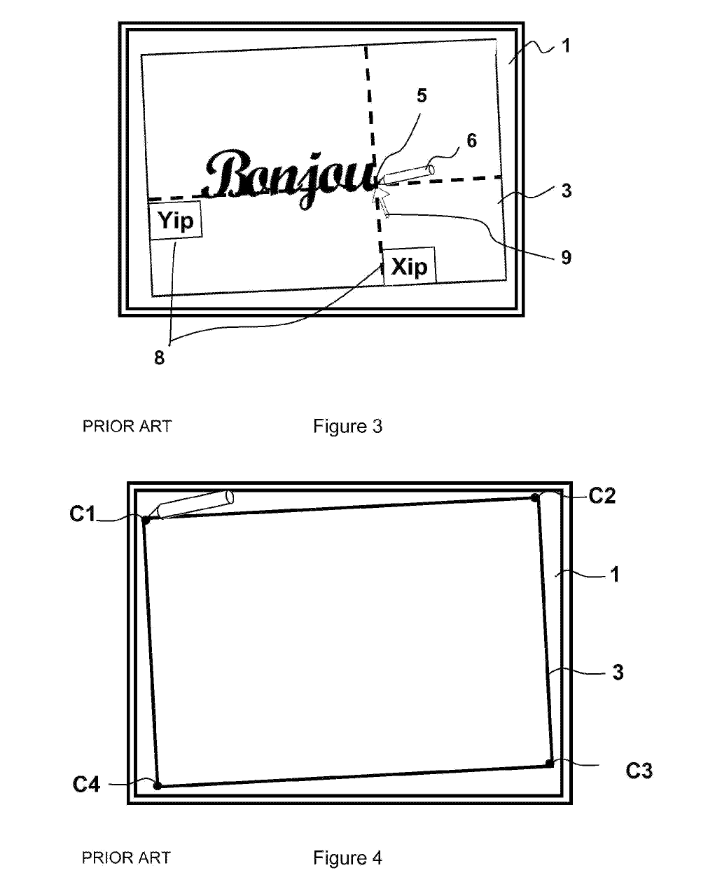

FIG. 3 shows the coordinates (Xip, Yip) (8) of the point (5) in the coordinates of the projected image (3). According to the type of material, the change of coordinates (Xtb, Ytb) into coordinates (Xip, Yip) is calculated:

either by means of a specific processor, that can be physically connected to the interactive whiteboard,

or by the computer (2), that must then be provided with a specific software.

In order to determine the values of the parameters that will permit the transformation of coordinates (Xtb, Ytb) into coordinates (Xip, Yip), it is necessary to initially register the position of the image (3) projected by the video projector (4) to the touch screen (1). This operation is performed, for example, by registering the position of the four corners C1, C2, C3, C4 of said projected image (see FIG. 4) by successively pointing to them on the touch screen (1).

The coordinates Xip and Yip of the point (5) are then used by the computer (2), which assigns to the computer cursor (9) (usually controlled by the computer mouse) such a position that the cursor (9) points to the position (Xip, Yip) in the coordinates of the projected image (3) (see FIG. 3). It results therefrom that the image of the cursor (9), which is formed by the computer (2) and overlaid on the digital image (10) it generates, is projected at the same place on the touch screen (1) as the point (5) pointed by the operator (see FIG. 1).

To sum up, the operator controls the position of the cursor (9) of the computer (2) by moving his/her finger or the pen (6) on the touch screen (1).

On the other hand, controlling the computer (2) from the interactive whiteboard requires controlling at least one of the two buttons usually provided on the computer mice (left-click and optionally right-click). Several methods are used to generate the conventional left-click and right-click usually controlled from buttons provided on the mouse of a computer. By way of example, the left-click can be controlled by simply contacting the touch screen (1) with the finger or the pen (6); in certain devices, a right-click button is provided on the pen (6), which generates a specific pulse detected by the touch screen, then transmitted to the computer (2).

The touch-screen pointer may be a pen or a marker pen (ordinary or adapted to the touch screen) permitting, by contacting the touch screen, to perform pointing, cursor positioning, left- and right-click and writing functions.

The conventional configurations of interactive whiteboard provided with a great-size touch screen (1), as shown in FIG. 1, suffer from several drawbacks:

the touch screen (1) is bulky, heavy, impractical to install, and often expensive (the diagonal of such a device being conventionally of the order of 2 meters);

the interactive whiteboard has to be power supplied and has to transmit information to the computer (2), which may involve the use of expensive-to-install electrical cables;

the device is sensitive to misalignments between the touch screen (1) and the video projector (4) (such misalignments modify the (Xtb, Ytb) into (Xip, Yip) coordinate transformation parameter values and require at least to record again the corner positions of the projected image (3), as shown in FIG. 4);

the interaction with the screen is by definition tactile, and hence no remote interaction with the screen is possible.

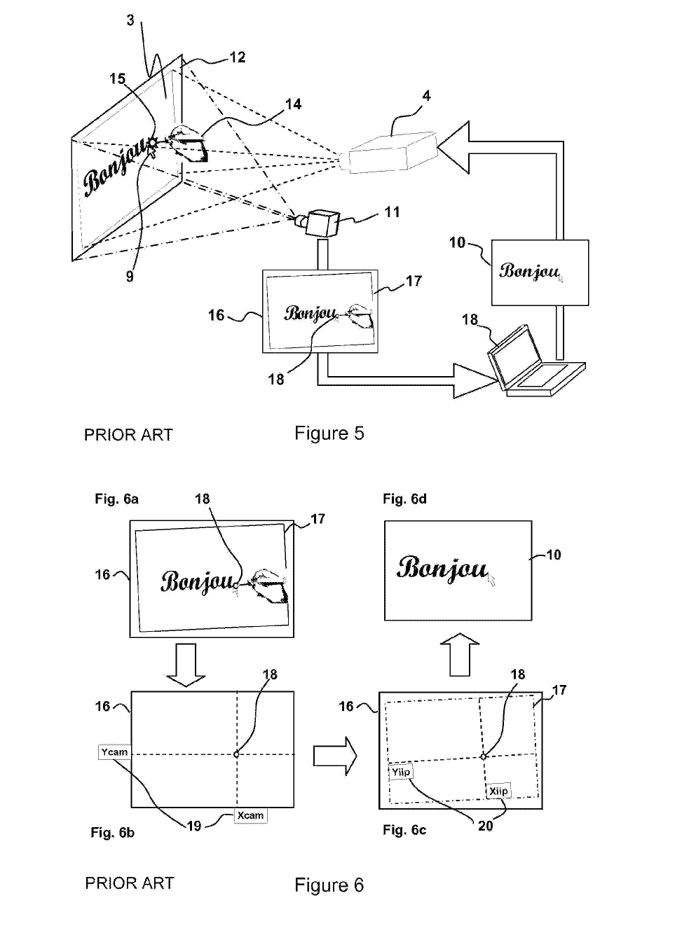

FIG. 5 shows a second conventional configuration of interactive whiteboard capable of some equivalent functions, without the use of a great-size touch screen, thanks to the use of a detection camera (11) that registers the position of an optical pointer (14) on a simple conventional projection screen (12).

Such devices comprise:

a video projector (4) that forms a projected image (3) on a conventional non-touch screen (12),

an optical pointer (14) handled by an operator, which permits to form a light mark (15) on the screen (12). Said light mark (15) is generally created by projecting a reduced-size light spot to the screen (12), wherein this spot may be emitted, for example, by a light-emitting diode fixed to the end of the optical pointer (14), generating a near-infrared light,

a detection camera (11) in the focal plane (16) of which is formed an projected-image image (17) and the light mark image (18). This camera (11) may be provided with an optical filter transmitting specifically the near-infrared, which facilitates the detection of the light mark image (18), and

a calculation device connected to the camera (11), comprising a computer (2) and possibly one or more complementary electronic cards accelerating the image processing. The image provided by the camera (11) is processed by said device in such a way to:

detect the position of the light mark image (18) in the focal plane (16) of the camera (11). Generally, this operation is performed by means of a thresholding operation, the system being set so that the intensity of the light mark image (18) in the selected spectral band is above this threshold, contrary to the rest of the image formed in the focal plane (16) (see FIGS. 6a and 6b),

calculate the abscissa and ordinate Xcam and Ycam (19) of the light mark image (18) in the coordinates of the focal plane (16) (for example by calculating the barycentre position of the thresholding-selected area) (see FIG. 6b). The coordinates Xcam and Ycam are then used to determine the coordinates Xiip and Yiip (20) of the light mark image (18) in the coordinates of the image taken back by the camera of the projected image (17) (see FIG. 6c).

According to the calculation device architecture, the image processing and coordinate changing operations are:

either performed by a specific processor included in the camera (11) (the latter taking the form of a smart camera),

or performed directly by the computer (2) that receives the images delivered by the camera and that must be provided with a specific software,

or processed in part by a specific processor (that can perform the image processing operations) and by the computer (2) (that can just manage the coordinate changes).

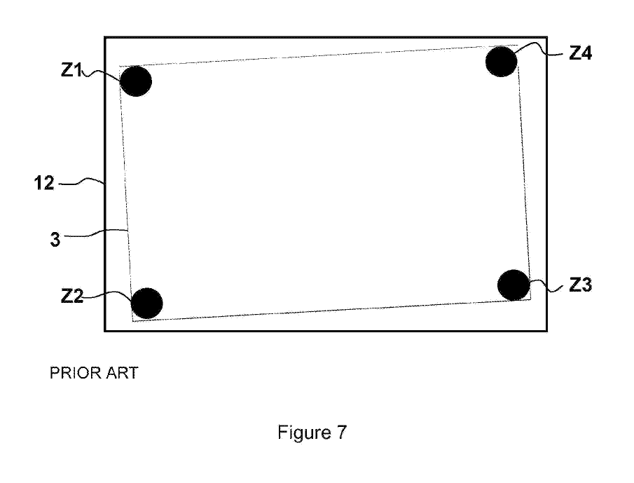

In order to determine the values of the parameters that will permit the transformation of coordinates (Xcam, Ycam) (19) into coordinates (Xiip, Yiip) (20), it is necessary to initially register the position of the image of the projected image (3) with respect to the focal plane (16) of the camera (11). This operation may be performed automatically, with the camera (11) recording, for example, an image of the 4 areas Z1, Z2, Z3, Z4 of a specific test pattern projected to the screen (see FIG. 7), wherein the position of said area image in the focal plane (16) can be automatically recognized by the device.

The coordinates Xiip and Yiip of the light mark image (18) are then used by the computer (2), which assigns to the computer cursor (9) such a position that the latter points to the coordinates Xiip, Yiip in the coordinates of projected-image image (17) (this position being usually controlled by a mouse connected to the computer).

It results therefrom that the image of the cursor (9), which is generated by the computer (2) and overlaid on the digital image (10), is projected on the screen (12) at the same place as the light mark (15) generated by the optical pointer (14) (see FIG. 5).

Therefore, the operator controls the position of the cursor (9) of the computer (2) by moving the optical pointer (14) on the screen (12).

In this type of device using a camera (11) and an optical pointer (14) emitting a light mark (15), the right- and left-click commands are transmitted to the computer (2) by operating the buttons provided on the optical pointer (14), said buttons causing a time modulation of the light intensity of the light mark (15) captured by the camera (11).

The interactive whiteboards based on the use of a camera and an optical pointer are far lighter in weight, less expensive, easier to install than the devices using a touch screen, which require the use of a specific screen. On the other hand, the systems based on a camera are easier to set, as the initial projected-image position registering can be performed automatically. Such systems permit the user to remotely interact with the screen to perform pointing, cursor positioning, left- and right-click functions. However, these systems have drawbacks.

Indeed, the devices using a camera are penalized because it is necessary that the camera can capture the image of the light mark generated by the optical pointer on the screen in order to calculate the position thereof, and because the stray light may disturb the camera operation.

On the one hand, it happens that the operator that holds the optical pointer hides the light mark projected on the screen with respect to the camera. It prevents the detection of the optical pointer position and the calculation of the cursor position, which makes the device inoperative. Such disturbances do not occur when a touch screen is used.

On the other hand, the devices using a camera may be disturbed when a high-intensity stray illumination is received by the screen. Stray-light points or bands frequently appear on the screen because of stray reflections of the ambient radiation (sun rays, artificial light or image projection beam), for example on the eyeglasses or the watch of the operator. Such stray light is difficult to distinguish from a light mark generated by the optical pointer, and can cause erroneous positioning of the cursor. Such disturbances do not occur when a touch screen is used.

The lack of reliability of the devices such as interactive whiteboards using a camera constitutes a significant constraint to the diffusion thereof in schools, despite their advantages in terms of cost and simplicity of use.

The present invention aims to remedy these drawbacks and relates, more particularly, to the interactive display devices of the camera-based interactive whiteboard type. The invention provides a more reliable operation of this type of devices, while giving them new performances.

For that purpose, the present invention relates to an interactive display device comprising:

a projection screen,

a video projector capable of projecting an image to the screen,

an optical pointer comprising a mouse-click signal inputting button and a light source capable of emitting a pointing light beam toward the screen to form a light mark on the screen,

a detection camera capable of acquiring an image of the screen and of detecting an image of the light mark,

a processing system capable of generating a light mark detection signal and of calculating the position of the light mark in the detected image.

According to the invention, the optical pointer comprises, on the one hand, a contact or proximity detector capable of detecting a contact or a proximity between an end of the optical pointer and the screen, and of generating a light mark presence signal and, on the other hand, a radio transmitter; the processing system comprises a radio receiver; the radio transmitter is capable of transmitting to the radio receiver, on the one hand, a signal of validation of a mouse-click signal emitted by the optical pointer and, on the other hand, a light mark presence signal, and the processing system is capable of deducing a signal of validation of said light mark from the combination of the light mark detection signal and the light mark presence signal

According to various particular embodiments of the invention:

the optical pointer comprises a light-source control button capable of controlling the emission and interruption of a pointing light beam;

the optical pointer comprises a light source and an optical guide capable of guiding a light beam between said source and an end of the optical pointer, to form a pointing light beam;

the detector of contact or proximity between the optical pointer and the screen is an optical contact or proximity detector capable of detecting a projection of the light mark on the screen;

the optical pointer and the processing system comprise respectively a radio transmitter-receiver capable of communicating bidirectional radio signals between the processing system and the optical pointer;

the optical pointer is provided with a sound or buzzer alert means controlled by the radio link, to communicate alert messages to an operator;

the device comprises a plurality of optical pointers capable of generating a plurality of light marks on a same screen, each optical pointer comprising an identification means, and in that the processing system comprises an identification system capable of individually detecting and/or activating each optical pointer.

The invention also relates to an interactive display method comprising the following steps of:

projecting to a screen a video image coming from a video projector,

emitting a pointing light beam toward the screen to form a light mark on this screen by means of an optical pointer comprising a mouse-click signal inputting button,

acquiring an image of the projection screen and detecting an image of the light mark,

calculating the light mark position in the detected image and generating a light mark detection signal,

characterized in that it comprises the following steps of:

detecting a contact or a proximity between an end of the optical pointer and the screen,

transmitting a light mark presence signal by means of a radio link between the optical pointer and the processing system,

comparing the respective signals of light mark presence and light mark detection to generate a signal of validation of said light mark or a signal of device operation anomaly.

According to different embodiments, the method of the invention further comprises one or more of the following steps of:

transmitting a radio signal triggered following the emission of a light beam to form a light mark on the screen;

comparing a radio signal received following the emission of a light mark with a signal of camera light mark detection to detect a device operation anomaly;

the detection of an anomaly causes the display of a visual message in the projected image and/or the emission of a sound signal;

the image acquisition by means of the camera is synchronized with the emission of a light beam to form a light mark, by means of a radio signal delivered by the processing system to the optical pointer;

the image acquisition by means of the camera is triggered firstly when the optical pointer generates no light mark and secondly when the optical pointer generates a light mark, and said images with and without light mark are subtracted in order to improve the detection of said light mark.

The present invention also relates to the characteristics that will become more apparent from the following description and that must be considered independently or in any technically possible combination.

This description, given by way of non-limitative example, will permit to better understand how the invention can be realized, with reference to the appended drawings, in which:

FIG. 1 shows a touch board according to the state of the art;

FIG. 2 shows the principle of coordinate alignment between a touch screen and a projected image, according to the prior art;

FIG. 3 shows the principle of coordinate alignment between the processing system and a touch screen, according to the prior art;

FIG. 4 schematically shows a method of alignment by pointing the four corners of an image projected on a touch screen, according to the prior art;

FIG. 5 shows an interactive video projection system with an optical pointer and a camera, according to the prior art;

FIG. 6 shows the principle of interaction by means of an optical pointer and a video-detection system according to FIG. 5;

FIG. 7 schematically shows a method of alignment by pointing the four corners of an image projected on a screen of a system according to the prior art of FIG. 5;

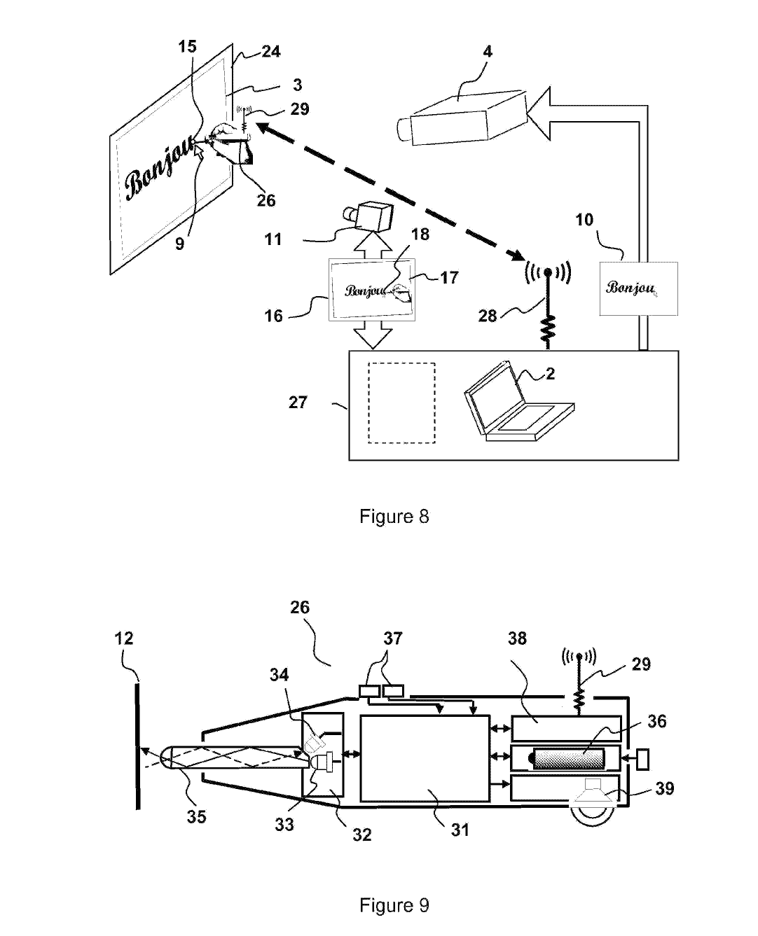

FIG. 8 shows an interactive display device according to the invention;

FIG. 9 shows an optical pointer according to the invention;

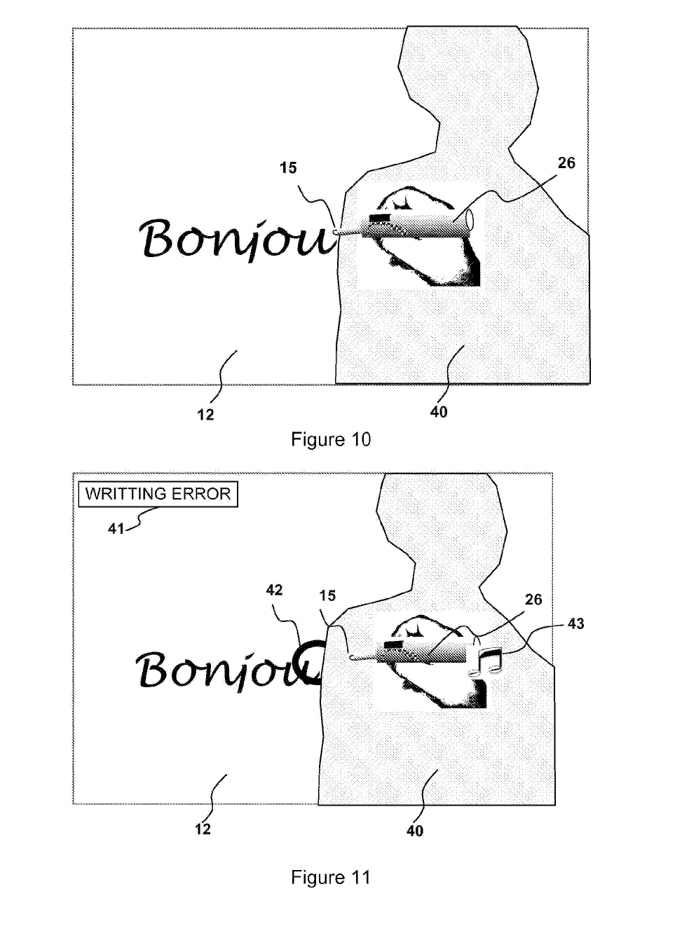

FIG. 10 shows an example of use of the pointer according to the invention;

FIG. 11 illustrates an embodiment of the method of the invention for detecting an operation anomaly;

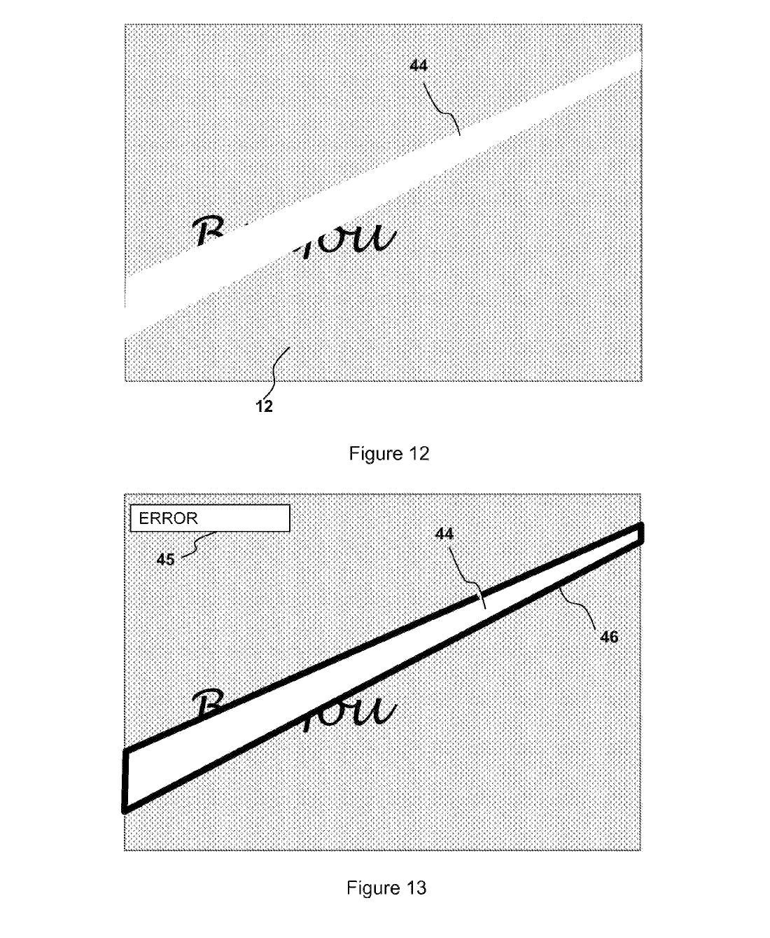

FIG. 12 illustrates another embodiment of the method of the invention for detecting another case of operation anomaly;

FIG. 13 illustrates the result of the method according to the invention for detecting the anomaly shown in FIG. 12.

The invention will be better understood from the following description of a particular embodiment, given by way of non-limitative example.

FIG. 8 shows the general architecture of the device, which comprises:

a video projector (4),

a screen (24) that receives the image (17) projected by the video projector (4),

a camera (11) that observes the screen (24),

an optical pointer (26) held by the operator, provided with a detector of contact or proximity with the screen (24), which emits an light mark when it is in contact or in proximity with the screen (24). On the other hand, the optical pointer (26) is provided with a radio transmitter (and possibly receiver) (29),

an electronic sub-assembly (27), comprising a computer (2), possibly assisted with one or more specific electronic cards, and connected:
to a radio receiver (28) that communicates with the radio transmitter of the optical pointer (26),
to the camera (11) that observes the screen (24),
to the video projector (4).

The electronic sub-assembly (27) performs the following operations:

it receives and analyses the content of the focal plane (16) captured by the camera (11) to determine the position of the light mark image (18) in the coordinates of the focal plane (16) of the camera (11), then in the coordinates of the projected-image image (17);

it generates the digital image (10) to be sent to the video projector (4), on which is overlaid the image of a cursor (9), the position of which on the screen (12) is overlaid on that of the light mark (15) emitted by the optical pointer (26).

A radio link between the optical pointer (26) and the electronic sub-assembly (27), and a sensor signaling the emission of a light mark (15) by the optical pointer (26), are provided in the device. In this configuration, the electronic sub-assembly (27):

receives over the air information transmitted by the optical pointer (26), representing:
the state of the contact sensor between the optical pointer (26) and the screen (12). This signal is referred to as the light mark presence signal;
the state of the lift-click and right-click provided on the optical pointer (26).

generates a light mark detection signal, as soon as the analysis of the image delivered by the camera (11) results in the calculated coordinates of such a light mark (15);

generates, possibly, various error messages, by comparing the light mark presence signal and the light mark detection signal;

generates signals that permit to synchronize the image capture by the camera (11) and the emission of the light mark (15) on the screen (12) by the optical pointer (26);

sends, via the transmitter to which it is connected, the radio signals bound for the optical pointer (26), intended to:
operate the loud-speaker of the optical pointer;
control the emission of the light mark (15).

FIG. 9 schematically shows the architecture of the optical pointer (26), according to a preferred embodiment, which comprises:

a microcontroller (31) that controls the general operation of the optical pointer (26);

an electro-optical sub-assembly (32) including a light diode (33) in charge of generating the light mark on the screen (12), and a light detector (34) that observes the light flow emitted by the light diode (33) after back scattering of the light to the screen (24), which permits the detection of the contact between the optical pointer (26) and the screen (12);

a light guide (35), in charge of routing the light flows between the light diode (33), the screen (12) and the light detector (34);

a sub-assembly (36) in charge of the optical pointer (26) power supply, including a rechargeable battery and a push-button for controlling the optical pointer activation;

two push-buttons (37) that control the computer left-click and right-click;

a radio transmitter-receiver sub-assembly (38);

a loud-speaker sub-assembly (39).

The light diode/light detector assembly (32) operates as follows. As soon as the optical pointer is activated, the microcontroller (31) sends short-duration electric pulses to the light diode (33) and analyses the light flow received in return by the light detector (34). As long as the optical pointer (26) is remote from the screen (12), this return flow is low. As soon as the optical pointer (26) is in contact or in proximity with the screen (12), this return flow becomes far more intense. In such conditions, the microcontroller (31) causes the continuous power supplying of the light diode (33), which generates the light mark on the screen; a light mark presence message is then transmitted over the air by the optical pointer (26) to the electronic sub-assembly (27); in normal conditions of use, the light mark (15) will be correctly captured by the camera (11).

In other words, the optical pointer (26) is equipped with a proximity detector. As used herein, “proximity detection” means the detection of a short distance (smaller than a few mm or a few cm) between the optical pointer (26) and the screen (24). When the user puts the optical pointer on the screen, the proximity detector detects the proximity of the screen and sends the information over the air to the processing electronic sub-assembly (27). As a result of the sending of this signal known as a light mark presence signal, the system (27) knows if the pointer rests or not against the screen.

On the contrary, when the proximity detection indicates that the optical pen is not in contact or in proximity with the screen, the detection of a light area optically detected by the camera and the processing system (or light mark detection signal) will be considered as a detection of stray light. Such stray light defines an area on the image, in which area no light spot is searched for, at least temporarily. When the pointer later comes back into contact or in proximity with the screen, the proximity detector sends a light mark presence signal. Once the stray light area is defined, the system searches for the light mark of the pointer in the rest of the detected image.

Advantageously, the end of the waveguide is approximately rounded to improve the comfort of use of the pointer at the time of contact with the screen, as well as its optical operation.

This device simultaneously permits:

to generate a light mark (15) on the screen (12), while saving the energy of the battery when the optical pointer (26) is not in contact with the screen (12),

to generate the information of contact or proximity between the optical pointer (26) and the screen (12), which will be used to transmit the light mark presence signal.

The left-click and right-click operate as follows. The left- and right-click signals are actuated by the operator acting on the push-buttons (37). These signals are transferred over the air to the electronic sub-assembly (27). The right- and left-click operations permit the operator to use the optical pointer (26) to control the computer (2) in the same manner as he/she would do with a conventional mouse, independently of the optical link between the camera (11) and the optical pointer (26).

The power supply (36) operates as follows. The power necessary to the operation of the optical pointer (26) is supplied by a battery. The starting-up of the optical pointer (26) is obtained by an action on a push-button. The microcontroller (31) is powered for a few minutes after the push-button has been actuated, this period being reset as soon as a single one function of the optical pointer (26) has been activated (action on any push-button, contact detection, reception of a message bound for the loud-speaker . . . ). As soon as the microcontroller (31) is activated, the light diode (33) emits light pulses so as to permit the detection of a contact between the optical pointer (26) and the screen (12).

According to a particular embodiment of the invention, the device comprises:

a video projector,

an optical pointer generating a light mark, provided with:
a radio transmitter;
two right- and left-click buttons.

When the operator operates the right-click or left-click buttons, the optical pointer generates specific signals that are transmitted by the radio transmitter provided in the optical pointer to:

a camera,

a computer connected to the camera, provided with a radio receiver, and connected to the video projector.

It is then possible to secure the right-click and left-click functions of an interactive whiteboard that uses a camera. Indeed, the right-click and left-click control signals, transmitted over the air by the optical pointer, are received by the receiver connected to the computer and taken into account by the latter, and that even if the camera does not see the light mark emitted by the optical pointer.

According to another particular embodiment of the invention, the device comprises:

a video projector,

an optical pointer generating a light mark, provided with:
a radio transmitter,
two right-click and left-click buttons,
a sensor detecting the contact between the optical pointer and the screen. The sensor activation causes the generation of the light mark on the screen by the optical pointer (for example, in the form of the emission of an infrared spot).

Radio signals are transmitted by the transmitter provided in the optical pointer when the operator actuates the right-click or left-click buttons. On the other hand, when the optical pointer is in contact or in proximity with the screen (this signal is hereinafter referred to as a light mark presence signal), another radio signal is transmitted by this transmitter to:

a camera,

a computer connected to the camera (the whole being possibly connected to a specific image-processing sub-assembly) and provided with a radio receiver.

Besides securing the right- and left-click detection, this embodiment permits to secure the detection by the camera of the light mark generated by the optical pointer. To that end, the device that receives information delivered by the camera generates a light mark detection signal, as soon as the analysis of the image delivered by the camera results in the calculated coordinates of such a light mark. The device operation is secured by the comparison of the light mark presence signal transmitted by the optical pointer with the light mark detection signal obtained by analysis of the image delivered by the camera:

When the light mark presence signal and the light mark detection signal are simultaneously present or absent, the device operates correctly.

If the light mark presence signal is present and the light mark detection signal is absent, the operator likely hides the light mark with respect to the camera. The device can then recognize the dysfunction and inform the operator thereof, for example by sending a light or sound signal to the operator, so that the latter becomes aware of the problem and remedies thereto by moving out of the camera field of view.

If the light mark presence signal is absent and the light mark detection signal is present, the camera likely sees a stray light. The device will then be able to notify this anomaly to the operator so that the latter remedies thereto.

According to another particular embodiment of the invention, the device comprises:

a video projector,

an optical pointer generating a light mark, provided with:
a radio transmitter-receiver,
two right-click and left-click buttons,
a sensor detecting the contact between the optical pointer and the screen. The sensor activation causes the generation of the light mark on the screen by the optical pointer (for example, in the form of the emission of an infrared spot),
a loud-speaker or a buzzer,

a camera,

a computer connected to the camera (the whole being possibly connected to a specific image-processing sub-assembly) and provided with a radio receiver.

Radio signals are transmitted by the transmitter provided in the optical pointer when the operator actuates the right-click or left click buttons. On the other hand, another radio signal is transmitted by this transmitter, when the optical pointer is in contact with the screen (this signal is hereinafter referred to as a light mark presence signal).

The system of communication between the optical pointer and the rest of the system, which is more sophisticated in this embodiment, permits the implementation of new functions. In particular, in the case where the device detects that the operator hides the light mark with respect to the camera, it is possible to make the device emit a signal toward the optical pointer. It is then possible to make this optical pointer emit a sound or a vibration as soon as the operator hides the optical pointer with respect to the camera, which helps the operator to be instantaneously aware of the situation.

It is also possible to make the light mark detection by the camera more reliable by synchronizing, by means of the radio communication channel implemented between the camera and the optical pointer, the shooting and light-emission sequences between these two sub-assemblies. It then becomes possible to detect more easily the position of the light mark emitted by the optical pointer, by subtracting two successive images, wherein one of which has been taken when the optical pointer was emitting no light mark.

Finally, it is possible to manage simultaneously several optical pointers (for example, the teacher's pen and the student's pen) on the same interactive whiteboard. To that end, it is provided that the radio transmitter connected to the computer sends to the various optical pointers successive coded commands of activation of their respective Light Mark, each of the optical pointers recognizing the moment at which it has to emit its own light mark. The device is thus capable of assigning to each of the active optical pointers the different coordinates of the light marks successively captured by the camera.

These alternatives are given by way of example and can be multiplied as a function of the accessories that will be added to the device.

By way of example, the optical pointer, provided with a screen-contact detection device and a radio transmitter, may be replaced by a laser pointer, also provided with a radio transmitter. The transmitter transmits a light mark presence signal as soon as the operator pushes the button triggering the laser beam emission, to remotely produce a light mark on the screen.

In the same way, this laser pointer can be provided with a radio receiver, which permits, for example, to synchronize the light mark emission by this laser pointer with those of other optical pointers; this particular device permits, for example, to the teacher to remotely control the interactive whiteboard operation, while a student is using an optical pointer provided with another radio receiver.

FIGS. 10 and 11 show the detection of a device operation error, related to the fact that the operator, whose silhouette (40) can be seen, hides the light mark (15) generated by the optical pointer (26) with respect to the camera (11).

In FIG. 10, it can be seen that the operator has written the beginning of the word “Bonjour” on the screen (12) but that the light mark (15) emitted by the optical pointer (26) will soon be hidden by the operator with respect to the camera (11).

In FIG. 11, the operator tries to finish writing the word “Bonjour” but the camera (11) does not see the image of the light mark (15) emitted by the optical pointer (26), this image being hidden by the operator (40). The electronic sub-assembly (27), which analyses the content of the focal plane (16) of the camera (11) does not generate anymore the light mark detection signal. On the other hand, this electronic sub-assembly (27) receives, by the channel of the radio receiver (28) to which it is connected, a message coming from the optical pointer (26), indicating that the light mark presence signal is active, as the optical pointer (26) is in contact with the screen (12). The electronic sub-assembly (27) deduces therefrom that an anomaly of operation is present. It can then generate several alerts for the operator, for example:

Two messages are displayed on the screen (12): a writing error message (41) informing the operator about the nature of the problem, and a light area (42) located at the place from where comes the problem. This place corresponds to an area surrounding the last position of the light mark (15) emitted by the optical pointer (26) that the camera (11) was able to detect.

The optical pointer (26) then receives a radio message that is sent to it by the electronic sub-assembly (27) via the transmitter (28), to activate a sound alert (43) emitted by its loud-speaker (39).

FIGS. 12 and 13 show the detection of a device operation error, related to the fact that an intense stray light (44) illuminates a part of the screen (12):

If the stray light intensity is equal to or higher than that of the light mark emitted by the optical pointer on the screen (12), the device will no longer be able to discriminate the two light sources.

In this case, the device could generate a light mark detection signal. If the optical pointer (26) is not in contact or in proximity with the screen (12), the light mark presence signal is absent. The electronic sub-assembly (27) deduces therefrom that an anomaly of operation is present. It can then generate alerts for the operator.

FIG. 13 illustrates the type of message provided to the operator so that the latter determines the origin of the problem and can remedy it. An alert message (45) is displayed, then the area (44), whose too high light intensity is detected, then highlighted (46). The area (44) can be temporarily neutralized to avoid the detection of any stray light.

According to a preferred embodiment of the method of the invention, when the processing system receives a light mark presence signal and a light mark detection signal, the system operates correctly and can define an area (42) centred on the coordinates of the detected light mark. Because the user moves the pen relatively slowly between two successive images taken by the camera (100 images/s), the processing system can limit the light mark detection to the only area (42). The system that detects both a light mark presence signal and a light mark detection signal defines a local interest area (42) around the position of the light mark. A large-enough local area (a few centimeters around the light mark) is defined, to be sure that the light mark of the next image will be in this area. On the next image coming from the camera, the system searches uniquely for the light mark in this local area (42). The local area moves with the current position of the light mark. If a stray light suddenly appears in the image field of view, but outside the local interest area (42), this stray light is not taken into account by the processing system (27). When the user moves the optical pointer away from the screen, the proximity detector detects that the pointer is no longer in contact or in proximity with the screen and a light mark non-presence signal is transmitted to the processing system. The system cancels the local interest area, to consider again the whole image (possibly out of the stray light area), and waits for the new detection of a light mark.

This method also permits to eliminate any stray light appearing outside the local interest area (42) as long as the pointer stays in contact with the screen and transmits a light mark presence signal.

The device of the invention advantageously uses an optical pointer that permits to interact optically via the camera and that is further provided with a detector of contact or proximity with the screen and a complementary means for radio communicating with the processing system.

The device and the method of the invention thus permit to secure the interactive display device operation by combining the optical detection of a light mark by the camera with one or more state signals of sensors located on the pen, these signals being transmitted by a radio link and being independent of the optical detection.

The radio link transmits in particular to the processing system of the computer the signals that permit to indicate:

whether the pen is in contact with the screen or not;

whether the user presses on a button of the pen or not.

1. An interactive display device comprising:
a screen (24),
a video projector (4) capable of projecting an image to the screen (24),
an optical pointer (26) comprising a mouse-click signal inputting button and a light source (33) capable of emitting a pointing light beam toward the screen to form a light mark (15) on the screen (24),
a detection camera (11) capable of acquiring an image of the screen and of detecting an image of the light mark,
a processing system (27) capable of generating a light mark detection signal and of calculating the position of the light mark (15) in the detected image,
characterized in that:
the optical pointer (26) comprises, on the one hand, a contact or proximity detector capable of detecting a contact or a proximity between an end of the optical pointer (26) and the screen (24), and of generating a light mark presence signal and, on the other hand, a radio transmitter (29),
the processing system (27) comprises a radio receiver (28),
the radio transmitter (29) being capable of transmitting to the radio receiver (28), on the one hand, a signal of validation of a mouse-click signal emitted by the optical pointer and, on the other hand, a light mark presence signal,
the processing system (27) being capable of deducing a signal of validation of said light mark from the combination of the light mark detection signal and the light mark presence signal.

2. A device according to claim 1, characterized in that the optical pointer (26) comprises a button for controlling the light source (33) capable of controlling the emission and interruption of a pointing light beam.

3. A device according to claim 1, characterized in that the optical pointer (26) comprises a light source (33) and an optical guide (35) capable of guiding a light beam between said source (33) and an end of the optical pointer (26), to form a pointing light beam.

4. A device according to claim 3, characterized in that the detector of contact or proximity between the optical pointer (26) and the screen (24) is an optical contact or proximity detector capable of detecting a projection of the light mark on the screen (24).

5. A device according to claim 1, characterized in that the optical pointer (26) and the processing system (27) comprise respectively a radio transmitter-receiver capable of communicating bidirectional radio signals between the processing system and the optical pointer (26).

6. A device according to claim 5, characterized in that the optical pointer (26) is provided with a sound or buzzer alert means controlled by the radio link, to communicate alert messages to an operator.

7. A device according to claim 1, characterized in that it comprises a plurality of optical pointers (26) capable of generating a plurality of light marks on a same screen (24), each optical pointer (26) comprising an identification means, and in that the processing system comprises an identification system capable of individually detecting and/or activating each optical pointer (26).

8. An interactive display method comprising the following steps of:
projecting to a screen (24) a video image coming from a video projector (4),
emitting a pointing light beam toward the screen (24) to form a light mark (15) on this screen by means of an optical pointer (26) comprising a mouse-click signal inputting button,
acquiring an image of the projection screen and detecting an image of the light mark (15),
calculating the position of the light mark (15) in the detected image and generating a light mark detection signal,
characterized in that it comprises the following steps of:
detecting a contact or a proximity between an end of the optical pointer (26) and the screen (24),
transmitting a light mark presence signal by means of a radio link (29) between the optical pointer (26) and the processing system (27),
comparing the respective signals of light mark presence and light mark detection to generate a signal of validation of said light mark or a signal of device operation anomaly.

9. A method according to claim 8, characterized in that the transmission of a radio signal is triggered following the emission of a light beam to form a light mark (15) on the screen (24).

10. A method according to claim 9, characterized in that it comprises a step of comparing a radio signal received following the emission of a light mark (15) with a signal of light mark detection by the camera (11) to detect a device operation anomaly.

11. A method according to claim 8, characterized in that the detection of an anomaly causes the display of a visual message (41 and 45) in the projected image and/or the emission of a sound signal

12. A method according to claim 9, characterized in that the image acquisition by means of the camera (11) is synchronized with the emission of a light beam to form a light mark (15), by means of a radio signal delivered by the processing system (27) to the optical pointer (26).

13. A method according to claim 9, characterized in that the image acquisition by means of the camera (11) is triggered firstly when the optical pointer (26) generates no light mark (15) and secondly when the optical pointer generates a light mark (15), and in that it comprises a step of subtracting images with and without light mark (15) so as to improve the detection of said light mark.

14. A device according to claim 2, characterized in that the optical pointer (26) comprises a light source (33) and an optical guide (35) capable of guiding a light beam between said source (33) and an end of the optical pointer (26), to form a pointing light beam.

15. A device according to claim 2, characterized in that the optical pointer (26) and the processing system (27) comprise respectively a radio transmitter-receiver capable of communicating bidirectional radio signals between the processing system and the optical pointer (26).

16. A device according to claim 3, characterized in that the optical pointer (26) and the processing system (27) comprise respectively a radio transmitter-receiver capable of communicating bidirectional radio signals between the processing system and the optical pointer (26).

17. A device according to claim 4, characterized in that the optical pointer (26) and the processing system (27) comprise respectively a radio transmitter-receiver capable of communicating bidirectional radio signals between the processing system and the optical pointer (26).

18. A device according to claim 2, characterized in that it comprises a plurality of optical pointers (26) capable of generating a plurality of light marks on a same screen (24), each optical pointer (26) comprising an identification means, and in that the processing system comprises an identification system capable of individually detecting and/or activating each optical pointer (26).

19. A device according to claim 3, characterized in that it comprises a plurality of optical pointers (26) capable of generating a plurality of light marks on a same screen (24), each optical pointer (26) comprising an identification means, and in that the processing system comprises an identification system capable of individually detecting and/or activating each optical pointer (26).

20. A device according to claim 4, characterized in that it comprises a plurality of optical pointers (26) capable of generating a plurality of light marks on a same screen (24), each optical pointer (26) comprising an identification means, and in that the processing system comprises an identification system capable of individually detecting and/or activating each optical pointer (26).
